(19) United States
(12) Patent Application Publication
(10) Pub. No.: US 2019/0294807 A1
(43) Pub. Date: Sep. 26, 2019

(54) INFORMATION MANAGEMENT APPARATUS

(71) Applicant: FUJI XEROX CO.,LTD., Tokyo (JP)

(72) Inventor: Kentaro TAKANO, Kanagawa (JP)

(73) Assignee: FUJI XEROX CO.,LTD., Tokyo (JP)

(21) Appl. No.: 16/049,837

(22) Filed: Jul. 31, 2018

(30) Foreign Application Priority Data
Mar. 22, 2018 (JP) 2018-054753

(51) Int. Cl. G06F 21/62

(52) U.S. Cl. CPC G06F 21/62; G06F 21/32

(57) ABSTRACT

An information management apparatus includes an acquisition unit that acquires biological information for specifying a mental state during a specific operation of a user having authority over the specific operation for information, and a control unit that performs control such that output of the information is suppressed in a case where the mental state specified by the acquired biological information is not within a preset normal range.

### CROSS-REFERENCE TO RELATED APPLICATIONS

This application is based on and claims priority under 35 USC 119 from Japanese Patent Application No. 2018-054753 filed Mar. 22, 2018.

### BACKGROUND

### (i) Technical Field

The present invention relates to an information management apparatus.

### (ii) Related Art

JP2004-164130A discloses a document management method using biological information in order to prevent illegal access to document data. The document management method includes a first step of registering biological information of a user who is allowed to use document data in a network server, a second step of acquiring biological information of a user who tries to access a database of the network server, and a third step of collating the biological information registered in the first step with the biological information acquired in the second step such that the biological information registered in the first step matches the biological information acquired in the second step, in which, in a case where the biological information registered in the first step does not match the biological information acquired in the second step in the third step, all users are prohibited from access to document data stored in the database, and a network terminal of a predetermined person is notified that illegal access to the database is detected according to a predetermined method.

### SUMMARY

Various methods for preventing an illegal action of a user not having authority to access information such as document data have been proposed, but it is hard to suppress an illegal action performed by a user having authority to access information, specifically, an action of causing the information to intentionally leak to a third party through an operation within the scope of authority.

Aspects of non-limiting embodiments of the present disclosure relate to a technique capable of suppressing an action of causing the information to intentionally leak through an operation within the scope of authority.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an information management apparatus including an acquisition unit that acquires biological information for specifying a mental state during a specific operation of a user having authority over the specific operation for information; and a control unit that performs control such that output of the information is suppressed in a case where the mental state specified by the acquired biological information is not within a preset normal range.

### BRIEF DESCRIPTION OF THE DRAWINGS

Exemplary embodiment(s) of the present invention will be described in detail based on the following figures, wherein:

FIG. 1 is a diagram illustrating a system configuration of an exemplary embodiment;

FIG. 2 is a functional block diagram illustrating a user terminal of the exemplary embodiment;

FIG. 3 is a functional block diagram illustrating an information management server of the exemplary embodiment;

FIG. 4 is a configuration block diagram illustrating the information management server of the exemplary embodiment;

FIG. 5 is a diagram (first) schematically illustrating a process of the exemplary embodiment;

FIG. 6 is a diagram (second) schematically illustrating a process according to the exemplary embodiment;

FIG. 7 is a flowchart illustrating the entire process according to the exemplary embodiment;

FIG. 8 is a flowchart illustrating another entire process according to the exemplary embodiment;

FIG. 9 is a flowchart illustrating the entire process according to still another exemplary embodiment;

FIG. 10 is a flowchart illustrating details of a user biological information acquisition process;

FIG. 11 is a flowchart illustrating details of another user biological information acquisition process;

FIG. 12 is a flowchart illustrating details of still another user biological information acquisition process;

FIG. 13 is a diagram (first) illustrating screen display on the user terminal;

FIG. 14 is a diagram (second) illustrating screen display on the user terminal;

FIG. 15 is a diagram illustrating another screen display on the user terminal;

FIG. 16 is a flowchart illustrating details of an information output suppression process;

FIG. 17 is a flowchart illustrating details of another information output suppression process;

FIG. 18 is a diagram illustrating screen display transition on the user terminal;

FIG. 19 is a diagram (first) illustrating another screen display transition on the user terminal;

FIG. 20 is a diagram (second) illustrating another screen display transition on the user terminal;

FIG. 21 is a diagram illustrating a system configuration according to a modification example;

FIG. 22 is a functional block diagram according to the modification example; and

FIG. 23 is a flowchart illustrating the entire process according to the modification example.

### DETAILED DESCRIPTION

Hereinafter, a description will be made of an exemplary embodiment of the invention with reference to the drawings.

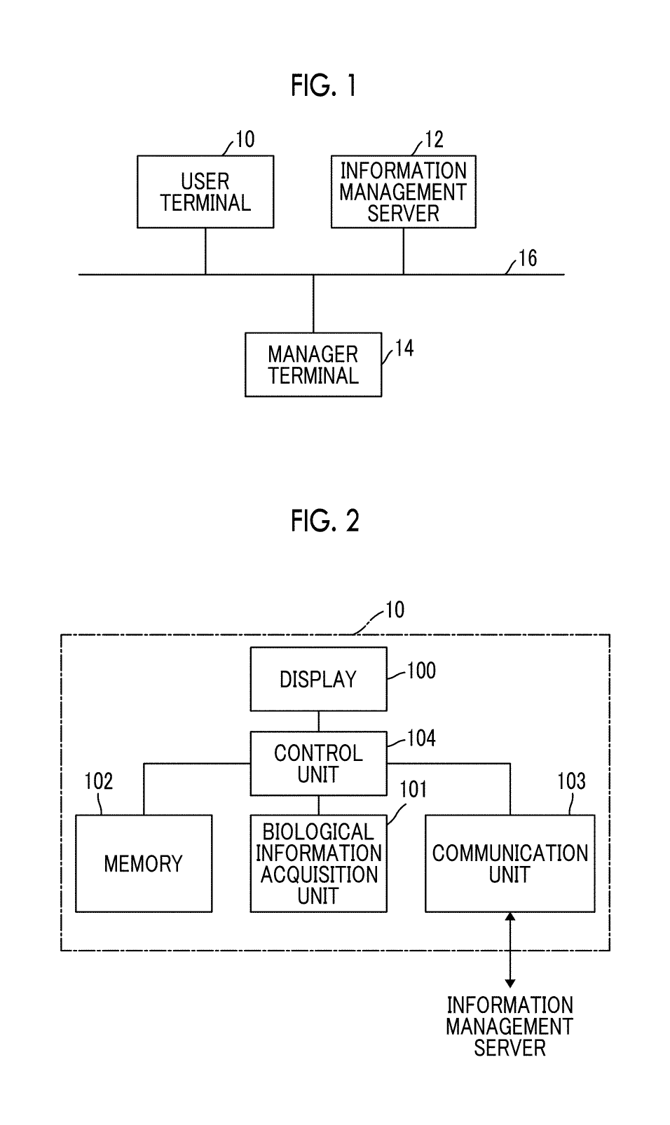

FIG. 1 is a diagram illustrating a system configuration according to the present exemplary embodiment.

A system includes a user terminal 10, an information management server 12, and a manager terminal 14. The user terminal 10, the information management server 12, and the manager terminal 14 are connected to each other via a communication line 16 such that data can be transmitted and received.

The user terminal 10 is a terminal operated by a user, and has a function of displaying information. The user terminal 10 is information terminal such as a tablet terminal or a personal computer, and displays, on a display unit, information such as document data stored in an internal memory or information such as document data acquired via the communication line 16 through the user's operation. The user has authority to use the user terminal 10, and is a user (hereinafter, referred to as an “authorized user”) having authority to display information on the display unit, that is, authority to be able to access information.

The information management server 12 is a server connected to the user terminal 10 via the communication line 16, and is a server managing information displayed on the user terminal 10. The information management server 12 functions as an information management apparatus, monitors display of information performed by the authorized user, and controls an operation of the user terminal 10 such that output of information is suppressed in a predetermined case. In a case where the authorized user operates the user terminal 10 and performs an illegal action of intentionally making principal information to leak by showing a third party the information, the information management server 12 performs a notification for suppressing the action, acquires biological information of the authorized user in a state in which the notification is recognized, and evaluates a probability that the authorized user may perform the illegal action by using the acquired biological information. As a result of the evaluation, output of the information is suppressed in a case where the probability of the illegal action is high. The suppression of the information output includes interruption or stopping of information display, a notification given to the manager terminal 14, and the like.

The manager terminal 14 is a terminal operated by a manager managing information. The manager terminal 14 is connected to the information management server 12 via the communication line 16, and receives a notification from the information management server 12 and displays the notification. The notification from the information management server 12 is a notification indicating that there is a possibility that the authorized user may perform an intentional information leakage action.

FIG. 2 is a functional block diagram illustrating the user terminal 10. The user terminal 10 includes a display 100, a biological information acquisition unit 101, a memory 102, a communication unit 103, and a control unit 104, as functional blocks.

The display 100 is a liquid crystal display or an organic EL display, and displays information such as document data or image data.

The biological information acquisition unit 101 acquires biological information of the authorized user. Any biological information may be used, but is biological information in which a mental state of the authorized user can be reflected, and is, specifically, a face image, a pulse, blood pressure, a brain wave, or a voice. The face image may be acquired with a camera, the pulse or the blood pressure may be acquired with a sensor or a smart watch attached to the arm, the brain wave may be acquired with electrodes attached to the head, and the voice may be acquired with a microphone. A tremor (shaking) of the hand of the authorized user holding the user terminal 10 may be acquired with a vibration sensor. A so-called lie detector which finds lies of a subject on the basis of face images or voices is well-known, and biological information used for the lie detector may be used in the present exemplary embodiment.

The memory 102 stores in advance information to be displayed on the display 100. The information to be displayed may be acquired from the outside via the communication line 16, and may be stored in the memory 102. The memory 102 stores biological information of the authorized user acquired from the biological information acquisition unit 101.

The communication unit 103 transmits and receives data to and from the information management server 12 via the communication line 16. Specifically, the biological information acquisition unit 101 acquires biological information of the authorized user in response to a command from the information management server 12, and the acquired biological information is transmitted to the information management server 12. Information to be displayed on the display 100 is suppressed in response to a command from the information management server 12. The communication unit 103 outputs a command received from the information management server 12 to the control unit 104.

The control unit 104 controls an operation of each unit of the user terminal 10. In other words, the control unit 104 displays information on the display 100 in response to an operation of the authorized user, displays a message indicating that biological information is acquired is displayed on the display 100 in response to a command from the information management server 12 in a case where the information is displayed on the display 100, and acquires the biological information by driving the biological information acquisition unit 101. The control unit 104 transmits the acquired biological information from the communication unit 103 to the information management server 12. The control unit 104 controls the display 100 in response to a command from the information management server 12 so as to suppress output of information.

The user terminal 10 may be configured with an information apparatus such as a tablet terminal including one or plural processors, a ROM, a RAM, an input device such as a keyboard or a touch switch, various sensors, a storage device such as an HDD or an SSD, a communication interface (I/F), and a display. The one or plural processors function as the control unit 104 by reading a processing program stored in the ROM or the storage device and executing the processing program. Cameras included in the various sensors function as the biological information acquisition unit 101. The keyboard or the touch switch receives an operation of the authorized user. The communication I/F functions as the communication unit 103. The display functions as the display 100.

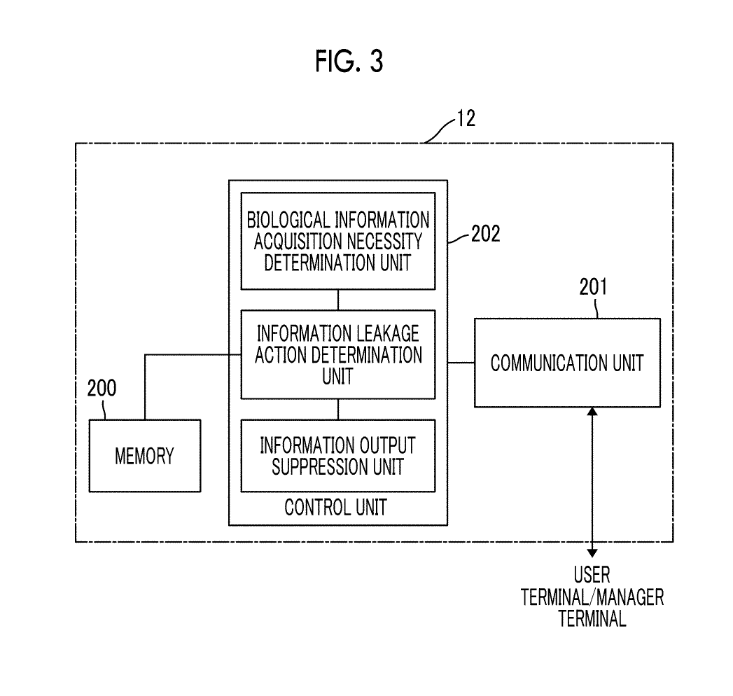

FIG. 3 is a functional block diagram illustrating the information management server 12. The information management server 12 includes a memory 200, a communication unit 201, and a control unit 202, as functional blocks.

The memory 200 stores information of the authorized user, for example, a user ID, a password, and a family member or friend relationship of the authorized user. The use of information regarding the family member or friend relationship will be described later.

The memory 200 stores biological information in a normal state of the authorized user as a reference value. For example, the biological information in a normal state is a face image in a normal state, a pulse rate in a normal state, a brain wave in a normal state, blood pressure in a normal state, and a speech waveform in a normal state.

The communication unit 201 transmits and receives data to and from the user terminal 10 and the manager terminal 14 via the communication line 16.

The control unit 202 controls an operation of each unit of the information management server 12. The control unit 202 includes a biological information acquisition necessity determination unit, an information leakage action determination unit, and an information output suppression unit.

The biological information acquisition necessity determination unit determines whether or not it is necessary to acquire biological information of the authorized user in a case where the authorized user operates the user terminal 10 to display information on the display 100. In other words, a problematic action is an action of intentionally making principal information to leak to a third party having no authority, and thus it is determined that biological information is required to be acquired in a case where conditions are satisfied in which displayed information is principal information, information is displayed in locations other than a location where display of the information is allowed, and there is a third party having no authority. Conversely, in a case where displayed information is not principal information, or information is displayed in a location (base) where the information is inherently allowed to be displayed, it is determined that biological information is not required to be acquired. In a case where it is determined that biological information is required to be acquired, the biological information acquisition necessity determination unit outputs a control command to the control unit 104 of the user terminal 10 via the communication unit 201, and causes the biological information acquisition unit 101 to acquires the biological information.

In a case where the biological information acquisition necessity determination unit determines that biological information is required to be acquired, the information leakage action determination unit determines a probability of an information leakage action by using the biological information of the authorized user acquired according to a determination result. Specifically, the acquired biological information is compared with the reference value stored in the memory 200 such that it is determined whether or not the biological information is deviated from the reference value, and it is determined that there is a probability of an information leakage action in a case where the biological information is deviated. For example, lateral symmetry of a fine expression of the authorized user is compared with the reference value on the basis of a face image of the authorized user captured by a camera, and, in a case where the symmetry is different from the reference value by a predetermined proportion or more, it is determined that a mental state of the authorized user is different from that in a normal state, and thus there is a probability of an information leakage action. Alternatively, a voice of the authorized user acquired with a microphone is compared with a reference voice, and, in a case where the voice is different from the reference voice by a predetermined proportion or more, it is determined that a mental state of the authorized user is different from that in a normal state, and thus there is a probability of an information leakage action. In a case where it is determined that the current state of the authorized user is not reliable on the basis of acquired biological information regardless of whether or not the acquired biological information is deviated from the reference value, it may be determined that there is a probability of an information leakage action.

In a case where the information leakage action determination unit determines that there is a probability of an information leakage action, the information output suppression unit outputs a control command to the control unit 104 of the user terminal 10 via the communication unit 201, and suppresses output of information. The information output suppression unit outputs a notification indicating that there is a probability of an information leakage action to the manager terminal 14 via the communication unit 201 instead of output of a control command or along with output of the control command.

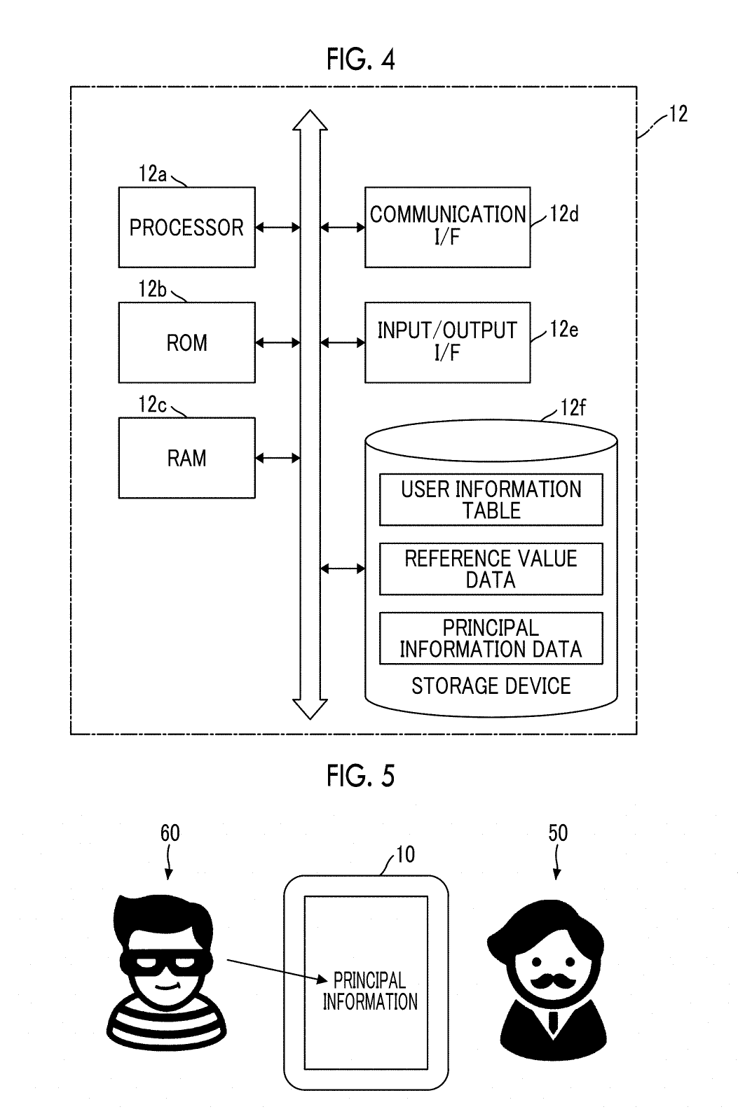

FIG. 4 is a block diagram illustrating a configuration of the information management server 12. The information management server 12 includes a processor 12a, a ROM 12b, a RAM 12c, a communication I/F 12d, an input/output I/F 12e, and a storage device 12f.

One or plural processors 12a function as the control unit 202, read a processing program stored in the ROM 12b or the storage device 12f, and executes the processing program by using the RAM 12c as a working memory, so as to realize the biological information acquisition necessity determination unit, the information leakage action determination unit, and the information output suppression unit.

The communication I/F 12d functions as the communication unit 201, receives position data of the user terminal 10 and data for determining importance of information displayed on the display 100 of the user terminal 10, and outputs the data to the processor 12a. In a case where it is determined that biological information is required to be acquired, the communication I/F 12d outputs a biological information acquisition control command to the control unit 104 of the user terminal 10. The communication I/F 12d receives biological information from the user terminal 10, and outputs the biological information to the processor 12a. The communication I/F 12d outputs a control command for suppressing output of information to the control unit 104 of the user terminal 10, and outputs a notification indicating that there is a probability of information leakage to the manager terminal 14.

The input/output I/F 12e is connected to an input device such as a keyboard or an output device such as a display. A person in charge of information management inputs data regarding the authorized user or a reference value of biological information via the input/output I/F 12e. Such data may be input from another terminal connected to the communication line 16 via the communication I/F 12d.

The storage device 12f functions as the memory 200, and stores a user information table, reference value data, and principal information data. The user information table stores information regarding the authorized user, that is, a user ID or a password, and information regarding a family member or a friend. As the reference value data, a reference value (normal range) of biological information in a normal state of the authorized user is stored. The reference value of biological information stored as the reference value data corresponds to biological information acquired by the user terminal 10. In other words, in a case where biological information acquired by the user terminal 10 is a face image of the authorized user, the reference value data includes a face image in a normal state. As the principal information data, principal information which is selected in advance from among pieces of information which may be displayed on the user terminal 10 is stored. A specific keyword or a specific type may be stored as the principal information data, and document data including such a specific keyword or document data classified into the specific type may be specified as principal information. The storage device 12f may store position data of an area (base) in which principal information can be handled.

FIG. 5 schematically illustrating an illegal action which is a suppression target in the present exemplary embodiment. An authorized user 50 may operate the user terminal 10 within the scope of the authority thereof so as to display principal information. There is no problem in a case where only the authorized user views principal information, or another person having authority to access principal information views the principal information. However, an action is an illegal action in which the authorized user 50 operates the user terminal 10 and displays principal information such that a third party (a so-called industrial spy) 60 not having authority to access principal information can view the principal information, and is required to be suppressed.

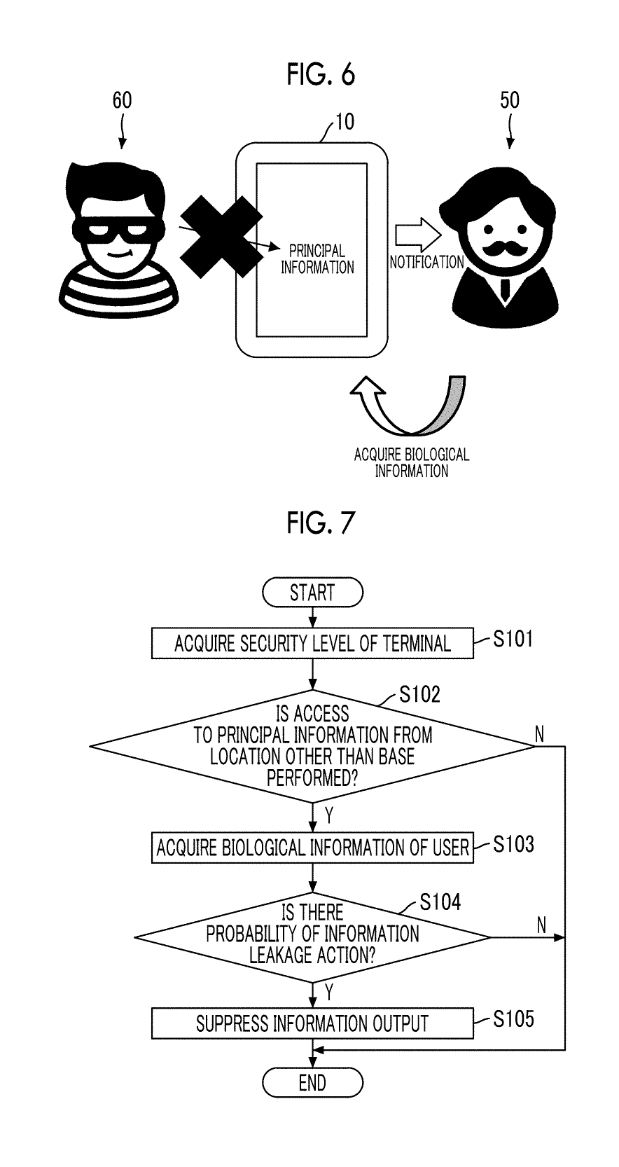

Therefore, as illustrated in FIG. 6, in a case where the authorized user 50 operates the user terminal 10 within the authority thereof, and displays principal information, a notification indicating that biological information is acquired is sent to the authorized user 50, and the biological information is acquired in a state in which the authorized user 50 recognizes the notification. In a case where a mental state of the authorized user 50 is deviated from a normal range by using the acquired biological information, a restriction is performed such that a third party having no authority to access the principal information cannot view the principal information, or cannot be maintained in the state even though the third party views the principal information.

A fundamental principle of the present exemplary embodiment can be said to prevent information leakage to a third party through three-stage processes such as a first process in which the authorized user 50 is notified that biological information thereof is acquired to be under monitoring such that an information leakage action is restricted, a second process in which a notification indicating that biological information is acquired is performed such that a mental state is easily reflected in the biological information, and a third process in which information output is actually suppressed in a case where there is a probability of an information leakage action by using the acquired biological information.

Regarding an illegal action of information leakage, on the basis of the fact that there are a location where an illegal action is likely to occur and a location where an illegal action is not likely to occur, a notification may be easily performed or no notification may be performed in consideration of the authorized user's convenience in the latter location, and acquired biological information may be limited to biological information which can be simply and easily acquired. To summarize, a process may be adaptively changed according to a location where the user terminal 10 is operated.

Regarding importance of information, on the basis of the fact that there are information having relatively high importance and information having relatively low importance, in a case where importance is not relatively high, a notification may be easily performed or no notification may be performed in consideration of the authorized user's convenience, and acquired biological information may be limited to biological information which can be simply and easily acquired. To summarize, a process may be adaptively changed according to importance of information displayed on the user terminal 10.

FIG. 7 is a flowchart illustrating the entire process according to the present exemplary embodiment.

First, the information management server 12 acquires a security level of the user terminal 10 (S101). Specifically, position data of the user terminal 10 which is being operated by the authorized user is acquired. The position data may be acquired by a position sensor such as a GPS provided in the user terminal 10. A position may be detected by using Wi-Fi radio waves instead of the GPS. The position data may be acquired at the time when the authorized user logs into the user terminal 10 by inputting a user ID or a password.

Next, the information management server 12 determines whether or not the authorized user accesses principal information from a location other than the base by using the acquired position data (step S102). Whether or not the authorized user performs an operation is determined on the basis of the input user ID or password. Whether or not information is principal information is determined by collating information displayed on the user terminal 10 through an operation of the authorized user with principal information data stored in the storage device 12f. Whether or not access is performed from a location other than the base is determined by collating the acquired position data with position data of the base stored in the storage device 12f.

In a case where it is determined that the authorized user accesses the principal information from a location other than the base (YES in S102), the information management server 12 determines that biological information of the authorized user is required to be acquired, outputs a control command to the user terminal 10, and causes the user terminal 10 to acquire the biological information of the authorized user (S103). The biological information is acquired, for example, by capturing a face image of the authorized user with a camera of the user terminal 10. The acquired biological information is transmitted from the user terminal 10 to the information management server 12. The biological information is fundamentally acquired in a period until an operation of finishing display of principal information is received from reception of an operation of the authorized user for displaying the principal information, but may be acquired in a period in which, especially, principal information which is not to be disclosed to a third party.

The information management server 12 determines whether or not a mental state of the authorized user is a normal state by collating the acquired biological information with the reference value data stored in the storage device 12f, and thus determines a probability of an information leakage action (S104). In a case where the acquired biological information is deviated from the reference value by a predetermined proportion or more, and thus is not within a normal range, it is determined that there is a probability of an information leakage action, and thus an information output suppression process is performed (S105). For example, lateral symmetry of the acquired face image is compared with the reference value, and, in a case where the symmetry is different from the reference value by a predetermined proportion or more, it is determined that the symmetry is not within a normal range, and the information output suppression process is performed.

In a case where the authorized user does not access the principal information from a location other than the base (NO in S102), or there is no probability of an information leakage action (NO in S104), information output is allowed instead of suppression of information output.

In the process in FIG. 7, biological information is acquired in a case where the authorized user accesses principal information from a location other than the base, but biological information may be acquired in a case where a third party is present near the authorized user.

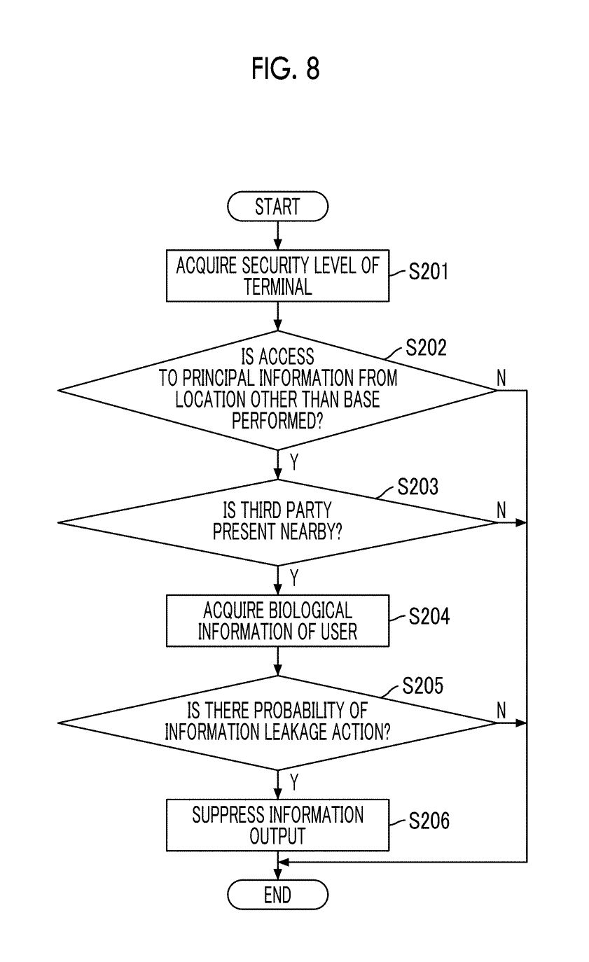

FIG. 8 is a flowchart illustrating the entire process in this case.

First, the information management server 12 acquires a security level of the user terminal 10 (S201). Specifically, position data of the user terminal 10 which is being operated by the authorized user is acquired.

Next, the information management server 12 determines whether or not the authorized user accesses principal information from a location other than the base by using the acquired position data (step S202).

In a case where it is determined that the authorized user accesses the principal information from a location other than the base (YES in S202), the information management server 12 further determines whether or not a third party other than the authorized user is present near the authorized user (S203). Whether or not the third party is present may be determined by imaging the periphery of the user terminal 10 with a camera of the user terminal 10, for example, a wide angle camera. The determination may be performed by displaying a question message having the content that “is anybody around you?” on the display unit of the user terminal 10 and letting the authorized user answer the question. In a case where it is determined that the authorized user accesses the principal information from a location other than the base, and the third party is present near the authorized user, the information management server 12 determines that biological information of the authorized user is required to be acquired, outputs a control command to the user terminal 10, and causes the user terminal 10 to acquire the biological information of the authorized user (S204). The biological information is acquired, for example, by capturing a face image of the authorized user with a camera of the user terminal 10. The acquired biological information is transmitted from the user terminal 10 to the information management server 12.

The information management server 12 determines whether or not a mental state of the authorized user is within a normal range by collating the acquired biological information with the reference value data stored in the storage device 12f, and thus determines a probability of an information leakage action (S205). In a case where the acquired biological information is deviated from the reference value by a predetermined proportion or more, and thus is not within a normal range, it is determined that there is a probability of an information leakage action, and thus an information output suppression process is performed (S206).

In a case where the authorized user does not access the principal information from a location other than the base (NO in S202), no third party is present near the authorized user (NO in S203), or there is no probability of an information leakage action (NO in S205), information output is allowed instead of suppression of information output.

In the process in FIG. 8, biological information is acquired in a case where a third party is present near the authorized user, but there may be a case where, even though a third party is present near the authorized user, the third party is accidentally present, and does not have the intention to view principal information. Therefore, biological information may be acquired in a case where a third party present near the authorized user actually views a screen of the user terminal 10.

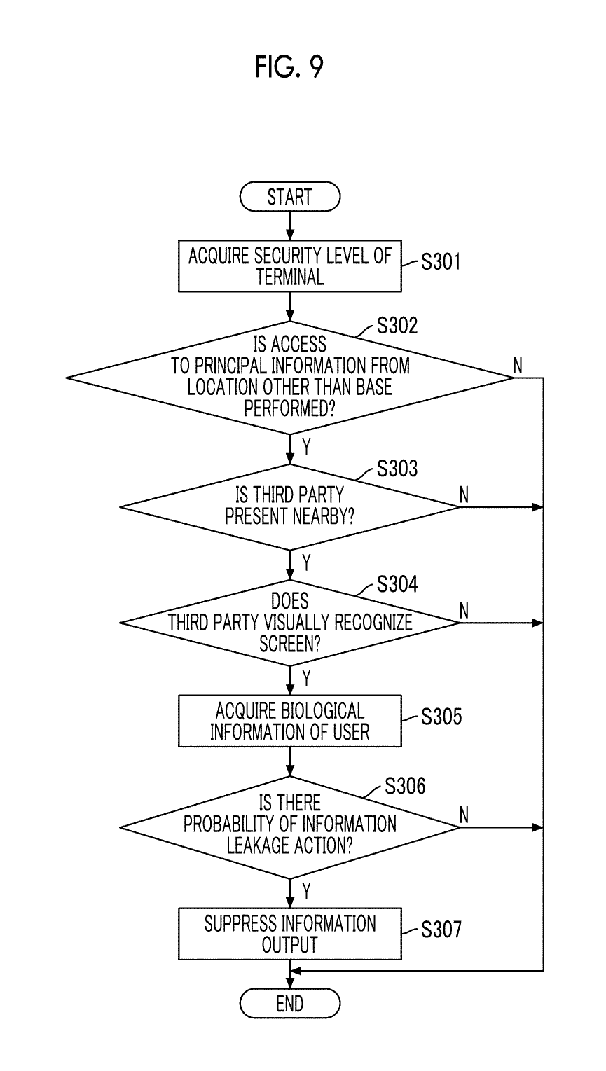

FIG. 9 is a flowchart illustrating the entire process in this case.

First, the information management server 12 acquires a security level of the user terminal 10 (S301). Specifically, position data of the user terminal 10 which is being operated by the authorized user is acquired.

Next, the information management server 12 determines whether or not the authorized user accesses principal information from a location other than the base by using the acquired position data (step S302).

In a case where it is determined that the authorized user accesses the principal information from a location other than the base (YES in S302), the information management server 12 further determines whether or not a third party other than the authorized user is present near the authorized user (S303). Whether or not the third party is present may be determined by imaging the periphery of the user terminal 10 with a camera of the user terminal 10, for example, a wide angle camera. The determination may be performed by displaying a question message having the content that “is anybody around you?” on the display unit of the user terminal 10 and letting the authorized user answer the question. In a case where the authorized user accesses the principal information from a location other than the base, and the third party is present near the authorized user, it is determined whether or not the third party visually recognizes the screen of the user terminal 10 (S304). Whether or not the third party visually recognizes the screen may be determined by detecting a direction of the face or a visual line direction on the basis of a face image of the third party. In a case where it is determined that the authorized user accesses the principal information from a location other than the base, the third party is present near the authorized user, and the third party visually recognizes the screen, the information management server 12 determines that biological information of the authorized user is required to be acquired, outputs a control command to the user terminal 10, and causes the user terminal 10 to acquire the biological information of the authorized user (S305). The biological information is acquired, for example, by capturing a face image of the authorized user with a camera of the user terminal 10. The acquired biological information is transmitted from the user terminal 10 to the information management server 12.

The information management server 12 determines whether or not a mental state of the authorized user is within a normal range by collating the acquired biological information with the reference value data stored in the storage device 12f, and thus determines a probability of an information leakage action (S306). In a case where the acquired biological information is deviated from the reference value by a predetermined proportion or more, and thus is not within a normal range, it is determined that there is a probability of an information leakage action, and thus an information output suppression process is performed (S307).

In a case where the authorized user does not access the principal information from a location other than the base (NO in S302), no third party is present near the authorized user (NO in S303), the third party is present but does not view the screen (NO in S304), or there is no probability of an information leakage action (NO in S306), information output is allowed instead of suppression of information output.

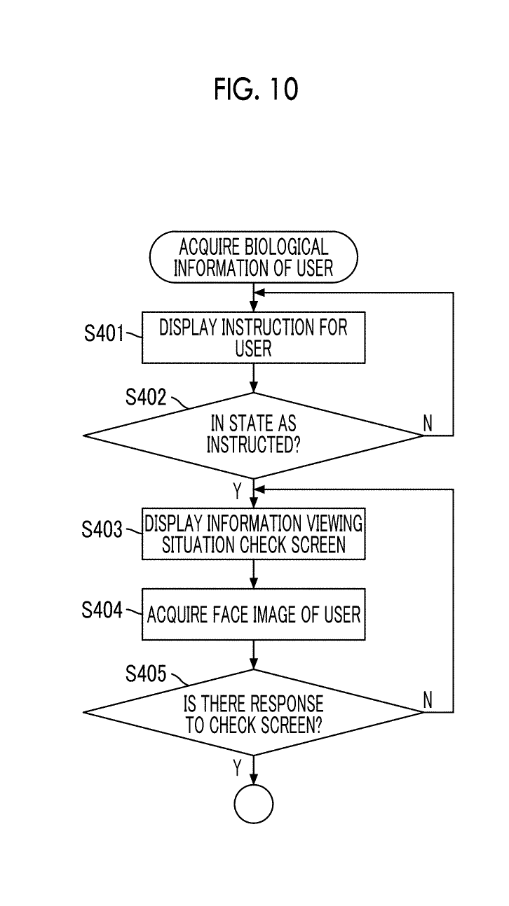

FIG. 10 is a flowchart illustrating a detailed process of acquiring biological information of the authorized user in the present exemplary embodiment, and corresponds to the process in S103 in FIG. 7, S204 in FIG. 8, or S305 in FIG. 9.

First, the information management server 12 outputs a control command to the user terminal 10, and displays an instruction for the authorized user (S401). The displayed instruction is, for example, a message having the content that “do not move the face in a state of being directed toward the camera in the front direction”. Voices may be output through a speaker.

The user terminal 10 determines whether or not the authorized user is in the state as instructed (S402). In a case where the authorized user stands still as instructed, the user terminal 10 then displays an information viewing situation check screen in response to a control command from the information management server 12 (S403). For example, a message having the content that “are you trying to disclose information to a person who is not allowed for disclosure?” is displayed on the check screen along with touch buttons such as “cancel” and “no”.

The authorized user visually recognizes the check screen, and gives a response by operating the “cancel” button or the “no” button.

The information management server 12 acquires, for example, a face image as biological information of the authorized user, and determines whether or not the face image is a face image after there is the response from the authorized user (S404 and S405). In a case where there is no response, the processes in S403 to S405 are repeatedly performed. Through the process, a face image of the authorized user after a response to the message having the content that “are you trying to disclose information to a person who is not allowed for disclosure?” is acquired. Acquiring a face image after a response to the check screen uses the fact that a mental state is different from a normal state in a case where there is a lie in a response content (the authorized user lies), and thus the mental state is reflected in the facial expression.

In the process in FIG. 10, a face image is acquired as biological information, but biological information to be acquired may be changed according to importance of information, and plural pieces of biological information may be acquired in a case where importance of information is relatively high.

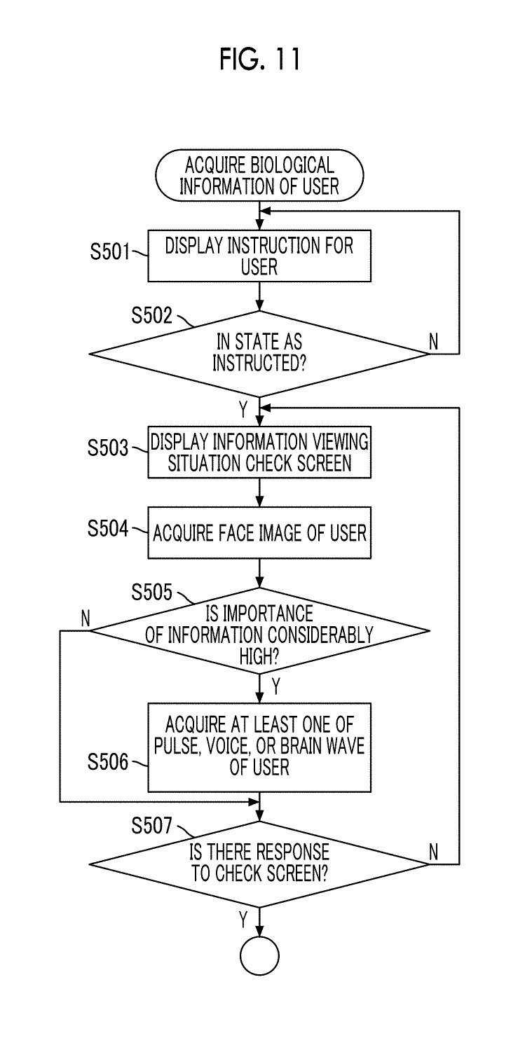

FIG. 11 is a flowchart illustrating a detailed process of acquiring biological information in this case.

First, the information management server 12 outputs a control command to the user terminal 10, and displays an instruction for the authorized user (S501). The displayed instruction is, for example, a message having the content that “do not move the face in a state of being directed toward the camera in the front direction”. Voices may be output through a speaker.

The user terminal 10 determines whether or not the authorized user stands still as instructed (S502). In a case where the authorized user stands still as instructed, the user terminal 10 then displays an information viewing situation check screen in response to a control command from the information management server 12 (S503). For example, a message having the content that “are you trying to disclose information to a person who is not allowed for disclosure?” is displayed on the check screen along with touch buttons such as “cancel” and “no”.

The authorized user visually recognizes the check screen, and gives a response by operating the “cancel” button or “no” button.

The information management server 12 acquires, for example, a face image as biological information of the authorized user (S504). In a case where importance of information to be displayed on the user terminal 10 is relatively particularly high, the information management server 12 outputs a control command to the user terminal 10 to acquire at least one of a pulse, a voice, or a brain wave in addition to the face image (S506). It is determined whether or not the face image and at least one of the pulse, the voice, or the brain wave are in a biological state after there is the response from the authorized user (S507). In a case where there is no response, the processes in S503 to S507 are repeatedly performed. Through the process, a face image, and a pulse or the like of the authorized user after a response to the message having the content that “are you trying to disclose information to a person who is not allowed for disclosure?” is acquired. Acquiring a face image, and a pulse or the like after a response to the check screen uses the fact that a mental state is different from a normal state in a case where there is a lie in a response content (the authorized user lies), and thus the mental state is reflected in plural pieces of biological information such as the facial expression, the pulse, or the like. In a case where importance of information is relatively high, it can be seen that determination is performed by putting an emphasis on accuracy rather than an authorized user's convenience. A technique of improving accuracy by using plural pieces of biological information is well known, and, for example, Hashem, Y., Takabi, H., GhasemiGol, M., & Dantu, R. (2016). Inside the Mind of the Insider: Towards Insider Threat Detection Using Psychophysiological Signals. J. Internet Serv. Inf. Secur., 6(1), 20 to 36, a technique is disclosed in which measurement and analysis are performed in real time by using electrocardiogram and brain waves, and an act of betrayal can be detected with accuracy of 90% or higher.

In the process in FIG. 11, in a case where importance of information is relatively high, plural pieces of biological information are acquired, but the type of biological information to be acquired may be changed depending on whether or not the user terminal 10 is moving.

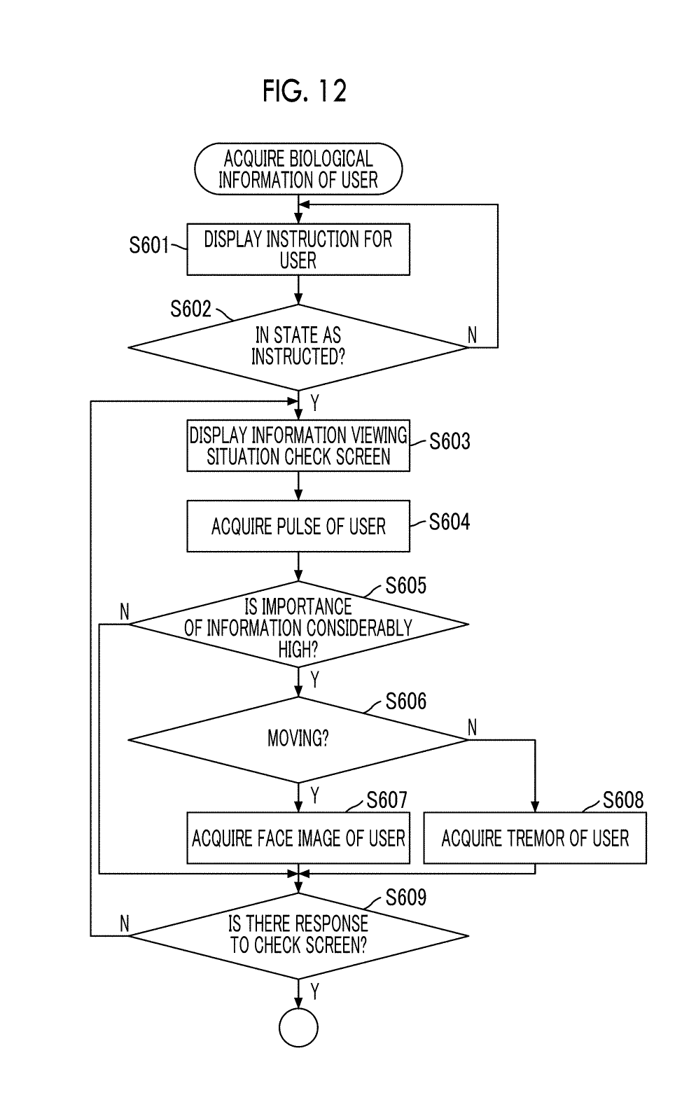

FIG. 12 is a flowchart illustrating a detailed process of acquiring biological information in this case.

First, the information management server 12 outputs a control command to the user terminal 10, and displays an instruction for the authorized user (S601). The displayed instruction is, for example, a message having the content that “accurately attach the pulse sensor”. Voices may be output through a speaker.

The user terminal 10 determines whether or not the authorized user stands still as instructed (S602). In a case where the authorized user stands still as instructed, the user terminal 10 then displays an information viewing situation check screen in response to a control command from the information management server 12 (S603). For example, a message having the content that “are you trying to disclose information to a person who is not allowed for disclosure?” is displayed on the check screen along with touch buttons such as “cancel” and “no”.

The authorized user visually recognizes the check screen, and gives a response by operating the “cancel” button or the “no” button.

The information management server 12 acquires, for example, a pulse as biological information of the authorized user (S604).

The pulse may be measured with the pulse sensor such as a smart watch attached to the arm, and may also be measured by pressing the finger against the camera and by using a blood flow on the basis of an amount of light transmitted through the finger. In a case where importance of information to be displayed on the user terminal 10 is relatively particularly high, the information management server 12 determines whether or not the user terminal 10 is moving (S606). Whether or not the user terminal 10 is moving may be determined on the basis of a temporal change of position data of the user terminal 10. In a case where the user terminal 10 is moving (YES in S606), a face image of the authorized user is acquired in addition to the pulse (step S607). On the other hand, in a case where the user terminal 10 is not moving (NO in S606), a tremor (shaking) of the hand of the authorized user holding the user terminal 10 is acquired with a vibration sensor (step S608). It is determined whether or not the pulse and either one of the face image or the tremor are in a biological state after there is the response from the authorized user (S609). In a case where there is no response, the processes in S603 to S608 are repeatedly performed. Through the process, in addition to a pulse of the authorized user after a response to the message having the content that “are you trying to disclose information to a person who is not allowed for disclosure?”, a face image is acquired in a case where the user terminal 10 is moving, and a tremor is acquired in a case where the user terminal 10 is not moving. The reason why a face image is acquired in a case where the user terminal 10 is moving is that it is generally hard to differentiate vibration due to movement from vibration in which a mental state is reflected.

In a case where a tremor (shaking) of the hand of the authorized user holding the user terminal 10 is detected even during movement, motion of the user terminal 10 during movement before held by the authorized user may be detected as an offset, and it may be determined whether or not there is a probability of an information leakage action by collating a tremor of the hand obtained by subtracting the offset with a reference value.

Voices of the authorized user may be acquired instead of a face image during movement, voices of the authorized user during movement may be detected as a reference value, and it may be determined whether or not there is a probability of an information leakage action by collating the reference value during movement with acquired voices.

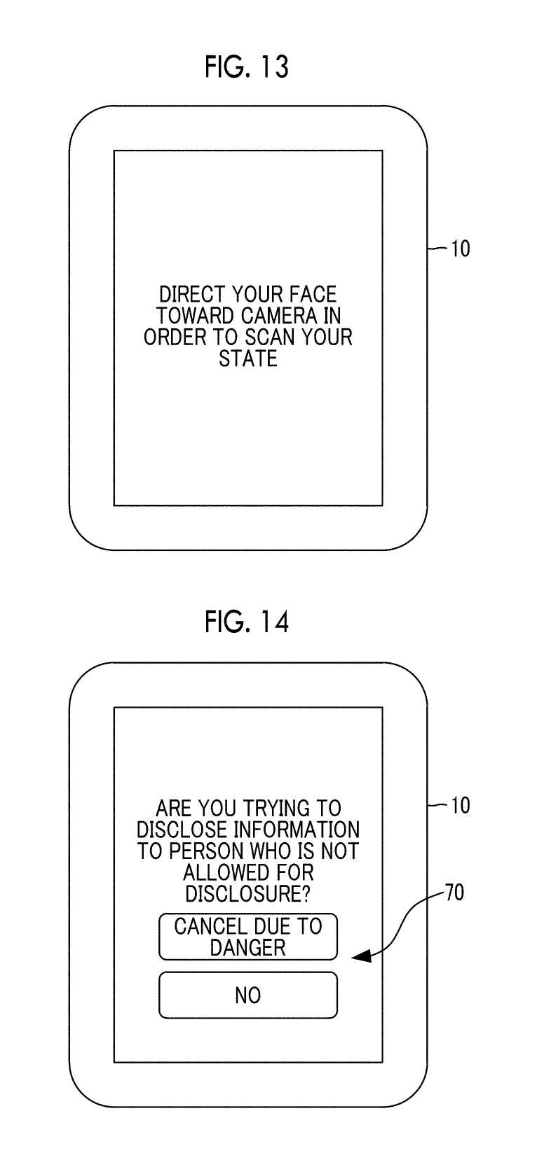

FIG. 13 illustrates a screen display example of the user terminal 10 in the process in S401, S501, or S601.

A message having the content that “direct your face toward the camera in order to scan your state” is displayed on the screen of the user terminal 10 by the control unit 104 having received a control command from the information management server 12. In a case of a pulse, a message having the content that “put your finger on the camera in order to scan your state” is displayed, and, in a case of a voice, a message having the content that “turn on the microphone in order to scan your state” is displayed.

FIG. 14 illustrates a screen display example of the user terminal 10 in the process in S403, S503, or S603. Two touch buttons 70 such as “cancel due to danger” and “no” are displayed along with the message having the content that “are you trying to disclose information to a person who is not allowed for disclosure?”. The authorized user gives a response by operating either one of the two touch buttons 70, and biological information after the response is acquired and is transmitted to the information management server 12.

Instead of the message, principal information may be emphasized by using a message having the content that “you are accessing principal information which is not to be disclosed to a third party; and are you trying to disclose information to a person who is not allowed for disclosure?”.

In a case where the authorized user intentionally causes principal information to leak to a third party, in a case where, of the two touch buttons 70, the “no” button is operated, the authorized user is lying, and thus a mental state thereof may be reflected in biological information.

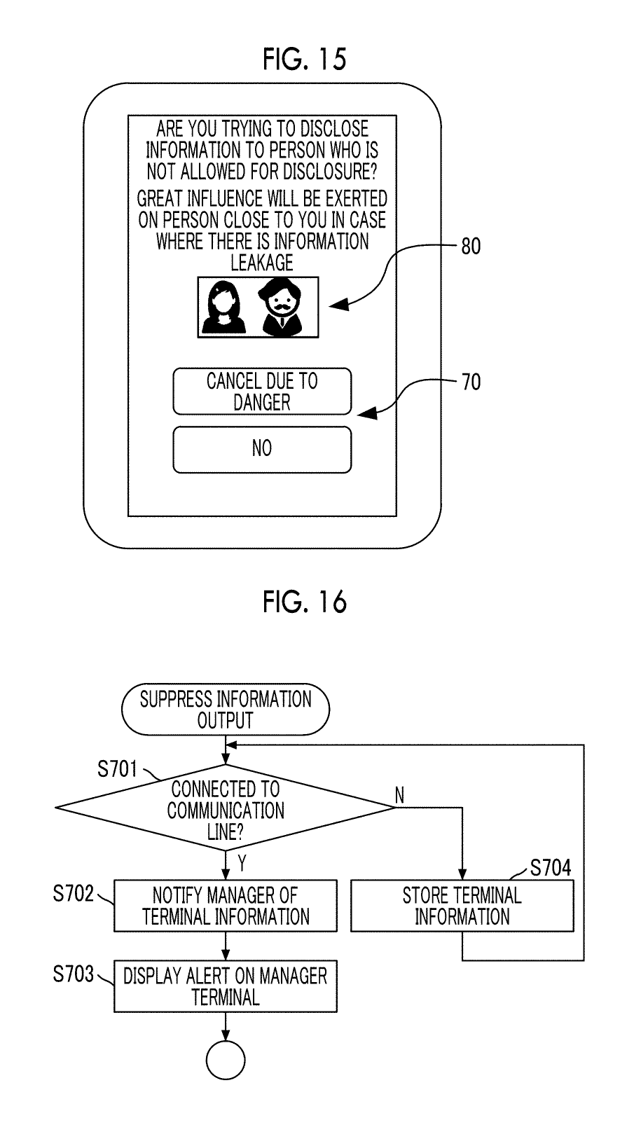

In addition to the message, information regarding a family member or a friend of the authorized user may be displayed, and an appeal to the authorized user's conscience may be performed by displaying information indicating that such a person is adversely affected in a case where an information leakage action is exposed. For example, as illustrated in FIG. 15, a picture 80 of a blood relative or a friend is displayed along with a message having the content that “are you trying to disclose information to a person who is not allowed for disclosure?; and the great influence will be exerted on a person close to you in a case where there is information leakage”. It is known that an illegal action is suppressed in a case where others are damaged, and thus a mental state can be more clearly reflected in biological information by displaying such a picture 80.

In addition to the picture 80 of a blood relative or a friend, a picture of a colleague with whom a good relationship is maintained in a workplace may be displayed. A colleague with whom a particularly good relationship is maintained may be acquired not only based on questionnaire but also by analyzing results of daily work evaluation such as others' evaluation. Comic images showing that a healthy life cannot be maintained due to information leakage may be displayed.

Next, a description will be made of an information output suppression process in a case where there is a probability of an information leakage action.

FIG. 16 is a flowchart illustrating details of an information output suppression process, and corresponds to the process in S105 in FIG. 7, S206 in FIG. 8, or S307 in FIG. 9.

First, the information management server 12 determines whether or not the manager terminal 14 is connected to the communication line 16 (S701). In a case where the manager terminal 14 is connected to the communication line 16, the manager terminal 14 is notified of information regarding the user terminal 10, for example, an ID of the user terminal 10, the name or an ID of the authorized user operating the user terminal 10, or information to be displayed, and thus a manager is notified that there is a probability of an information leakage action (S702). In a case where this notification is received, the manager terminal 14 displays an alert set in advance (S703). The alert display is, for example, that “there is access having a high probability of illegal action to principal information from a location other than the base”.

On the other hand, in a case where the manager terminal is not connected to the communication line 16, the information regarding the user terminal 10 is temporarily stored in the storage device 12f (S704), and is read from the storage device 12f when the manager terminal 14 is connected to the communication line 16, and a notification thereof is performed.

In a case where a notification is sent to the manager terminal 14, the information management server 12 may output a control command to the user terminal 10 so as to display information indicating that the notification has been sent to the manager on the display unit. For example, a message having the content that “the notification has been sent to the manager since an information leakage action is suspected” is displayed on the screen of the user terminal 10.

The manager who receives the notification takes necessary measures for the authorized user, but, in a case where plural notifications of the alert for a specific authorized user have been sent, the manager may take measures such as thorough security education guidance to the authorized user or deprivation of authority. An accessible level may be lowered stepwise according to the number of alerts.

In the process in FIG. 16, a notification is sent to the manager, but the manager terminal 14 to which a notification is to be sent may be changed depending on importance of information. For example, in a case where importance of information is considerably high, a notification may be sent to a terminal of a manager having higher authority. Display on the user terminal 10 may be suppressed instead of or along with a notification sent to the manager.

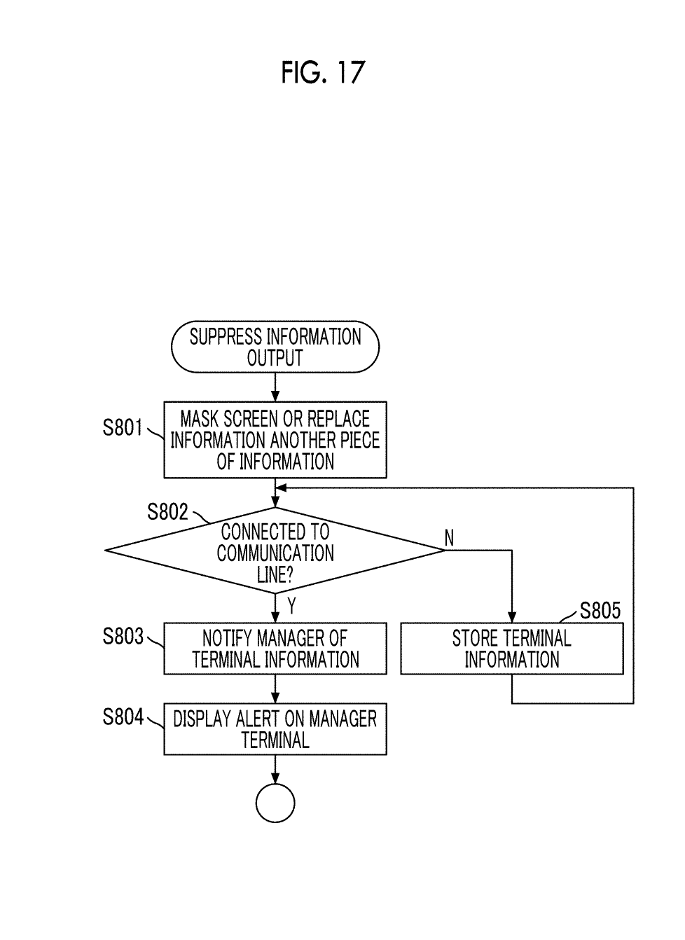

FIG. 17 is a detailed flowchart in this case.

In a case where it is determined that there is a probability of an information leakage action, the information management server 12 outputs a control command to the user terminal 10, and the control unit 104 of the user terminal 10 masks the screen of the user terminal 10 or displays separate information which is different from principal information so as to replace the principal information in response to the control command (S801). Thereafter, a notification is sent to the manager terminal 14 in the same manner as in FIG. 16 (S802 to S805).

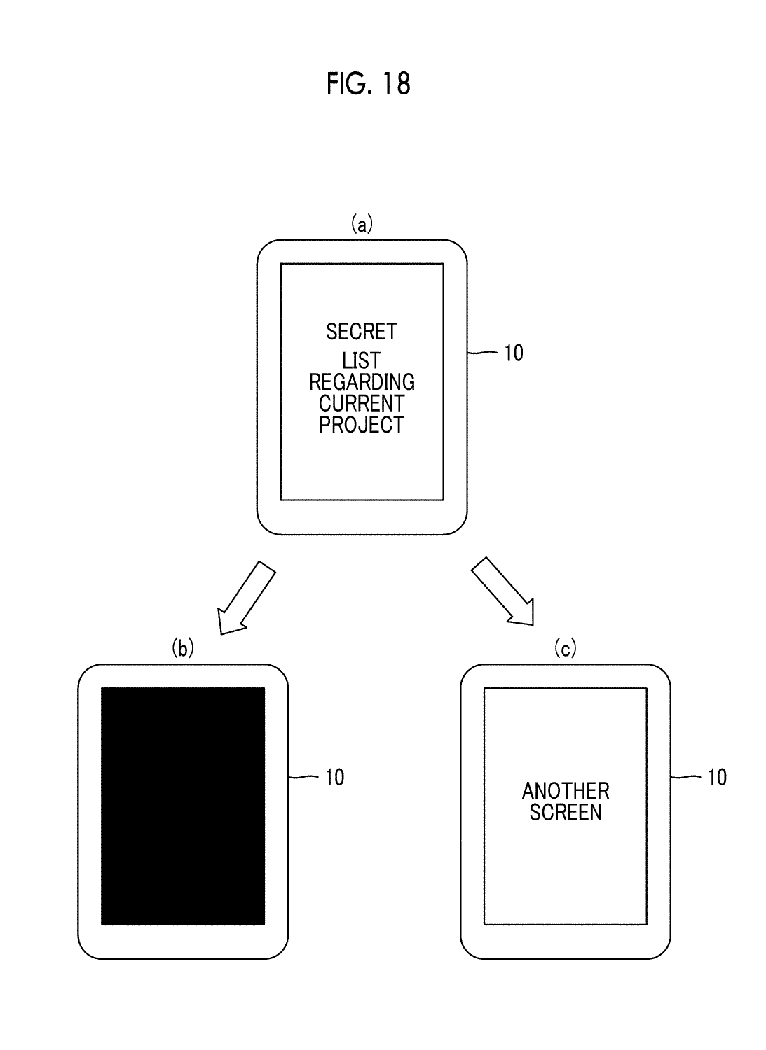

FIG. 18 illustrates a screen example of the user terminal 10.

As illustrated in (a) of FIG. 18, principal information is displayed, and the screen is displayed black (blackout) to be masked as illustrated in (b) of FIG. 18 in a case where there is a probability of an information leakage action. Alternatively, another screen (for example, a general landscape photograph) is displayed as illustrated in (c) of FIG. 18. Consequently, information leakage is more efficiently suppressed.

In FIG. 18, in a case where there is a probability of an information leakage action, the screen is uniformly masked, or principal information is replaced with separate information, but, in a case where principal information and non-principal information are displayed on the screen, only a portion in which the principal information is displayed may be masked, or the principal information may be replaced with another piece of information. The screen may be masked or principal information may be replaced with another piece of information only in a case where a third party actually visually recognizes the screen.

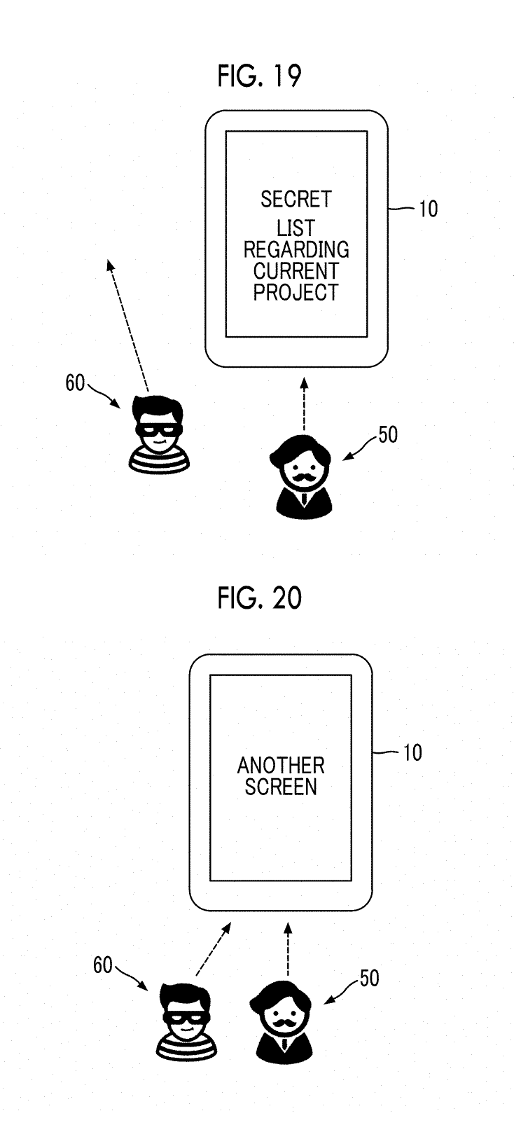

FIGS. 19 and 20 illustrate screen examples in this case. FIG. 19 illustrates a case where the third party 60 present near the user terminal 10 does not visually recognize the screen, and principal information is displayed without being changed. On the other hand, FIG. 20 illustrates a case where the third party 60 visually recognizes the screen, and principal information is replaced with another piece of information. Whether or not the third party 60 visually recognizes the screen may be determined on the basis of a facial direction or a visual line direction of the third party 60 in the same manner as in the process in S304 of FIG. 9.

As mentioned above, the exemplary embodiment of the invention has been described, but the present invention is not limited thereto, and may be variously modified. Hereinafter, modification examples will be described.

### MODIFICATION EXAMPLE 1

In the exemplary embodiment, as illustrated in FIG. 1, the user terminal 10 and the information management server 12 are separately provided and are connected to the communication line 16, but the user terminal 10 and the information management server 12 may be integrally provided. In this case, the user terminal 10 functions as an information management apparatus.

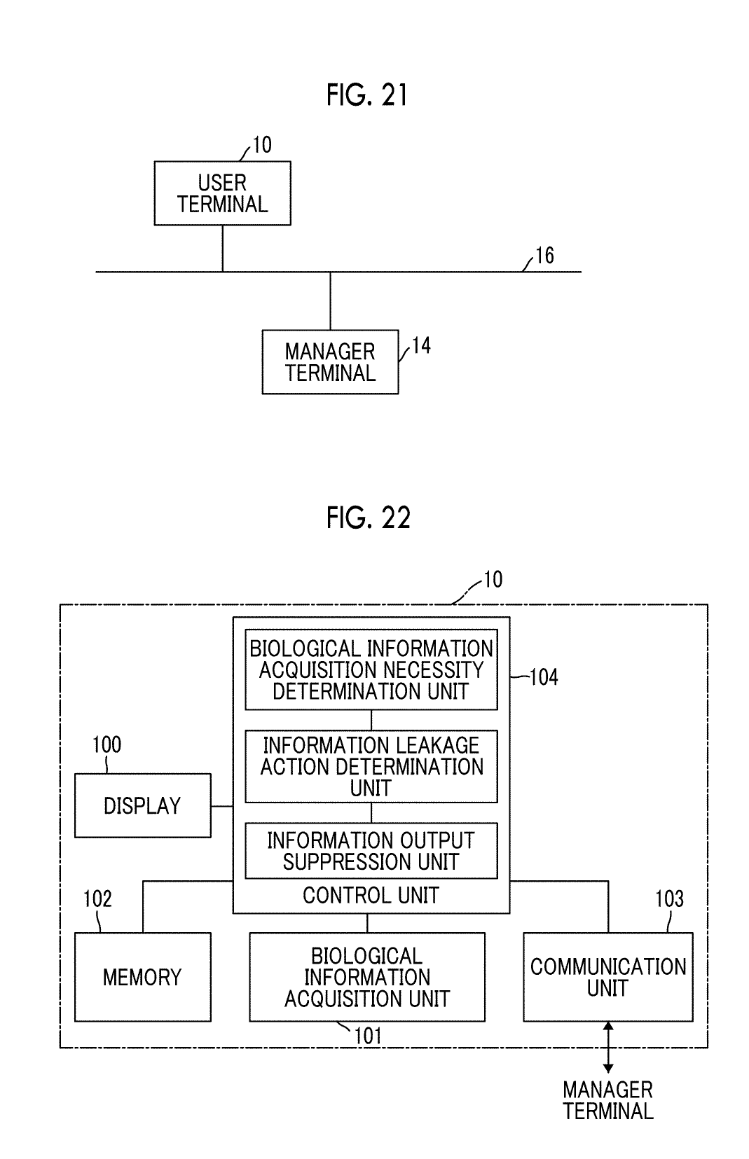

FIG. 21 illustrates a system configuration in a modification example. The user terminal 10 and the manager terminal 14 are connected to each other via the communication line 16. The user terminal 10 functions as the information management server 12, acquires biological information in a case where principal information is displayed through an operation of the authorized user, evaluates a probability of an information leakage action by using the acquired biological information, and suppresses information output in a case where there is a probability of an information leakage action.

FIG. 22 is a functional block diagram of the user terminal 10 in a modification example. The functional block diagram is an integration of the functional blocks illustrated in FIG. 2 and the functional blocks illustrated in FIG. 3. The control unit 104 includes a biological information acquisition necessity determination unit, an information leakage action determination unit, and an information output suppression unit, and determines whether or not biological information is required to be acquired by using position data of the user terminal 10 or importance of information, acquires biological information in a case where biological information is required to be acquired, and evaluates a probability of an information leakage action. In a case where there is a probability of an information leakage action, a notification is sent to the manager terminal 14 via the communication line 16, and the display 100 is controlled to mask principal information or to replace the principal information with another piece of information.

The memory 102 stores a user information table, reference value data, and principal information data in the same manner as the storage device 12f in FIG. 3. In addition thereto, position data of a base or data regarding information to be replaced may be stored. The memory 102 temporarily stores information regarding the user terminal 10 of which a notification is sent to the manager terminal 14 in a case where the manager terminal 14 is not connected to the communication line 16.

### MODIFICATION EXAMPLE 2

In the exemplary embodiment, it is determined that there is a probability of an information leakage action in a case where acquired biological information is deviated from a reference value, and information output is suppressed, but, thereafter, in a case where the acquired biological information is included in a normal range, the suppression of information output may be canceled. For example, as illustrated in FIG. 18, in a case where acquired biological information is deviated from a reference value, it is determined that there is a probability of an information leakage action, and thus the screen in (a) of FIG. 18 transitions to the screen in (b) of FIG. 18, but, thereafter, in a case where the acquired biological information is included in a normal range, the screen in (b) of FIG. 18 may return to the screen in (a) of FIG. 18.

In FIG. 20, information output is suppressed in a case where the third party 60 visually recognizes the screen of the user terminal 10, but the screen in FIG. 20 may also transition to the screen in FIG. 19 in a case where the third party 60 is not present near the user terminal 10.

### MODIFICATION EXAMPLE 3

In the exemplary embodiment, it is determined that there is a probability of an information leakage action in a case where acquired biological information is deviated from a reference value, and information output is suppressed, but, in a case where the user terminal 10 is moved during acquisition of biological information, information output maybe uniformly suppressed.

### MODIFICATION EXAMPLE 4

In the exemplary embodiment, it is determined whether or not access from a location other than a base is performed by acquiring position data of the user terminal 10, but entrance and exit for a room of which security is ensured may be managed, and it may be determined that access from a location other than a base is performed in a case where an authorized user leaves the room.

Even though access from a location other than a base is performed, in a case where the location other than the base is a location where display of principal information is originally permitted, it may be determined that biological information is not required to be acquired. Specifically, the location other than the base is, for example, a location of a company having concluded a non-disclosure agreement (NDA) for principal information. Such information may be stored in the storage device 12f or the memory 102 along with position data of the base. In a case where a schedule of the authorized user in time for which the user terminal 10 is operated indicates a business trip to a company having concluded a non-disclosure agreement (NDA) by using the schedule of the authorized user, it may be determined that the location other than the base is a location of the company having concluded the non-disclosure agreement (NDA).

### MODIFICATION EXAMPLE 5

In the exemplary embodiment, biological information is acquired in a case where a third party is present near the user, but, in a case where a superior or the like of the authorized user is also present, a probability of performing an information leakage action may be relatively low, and thus it may be determined that biological information is not required to be acquired. Whether or not a superior or the like of the authorized user is present may be determined by using position data of a terminal operated by the superior or the like. In other words, in a case where a distance between positions of the user terminal 10 and the superior terminal is within a predetermined value, it may be determined that the superior is present in the vicinity thereof. Whether or not the superior is present in the vicinity thereof may be determined by using schedule data of the authorized user and the superior.

### MODIFICATION EXAMPLE 6

In the exemplary embodiment, biological information is acquired in a case where access to principal information from a location other than the base is performed, but, in a case where the authorized user accesses the principal information, biological information of the authorized user may be acquired regardless of whether or not the authorized user is present in a location other than the base, a probability of an information leakage action may be evaluated by using the acquired biological information, and information output may be suppressed in a case where there is a probability of an information leakage action.

### MODIFICATION EXAMPLE 7

In the exemplary embodiment, biological information is acquired in a case where access to principal information from a location other than the base is performed, but an operation unit with which the authorized user can stop biological information acquisition in the user terminal 10 maybe provided. For example, a touch button such as “stop biological information acquisition” is displayed on the screen, and receives an operation of the authorized user.

However, for example, even though an operation on the operation unit is received, it is desirable that acquisition of biological information is stopped only in a case where biological information acquired hitherto is included in a normal range, and a stopping operation is disregarded such that biological information is continuously acquired in a case where the biological information is deviated from the normal range.

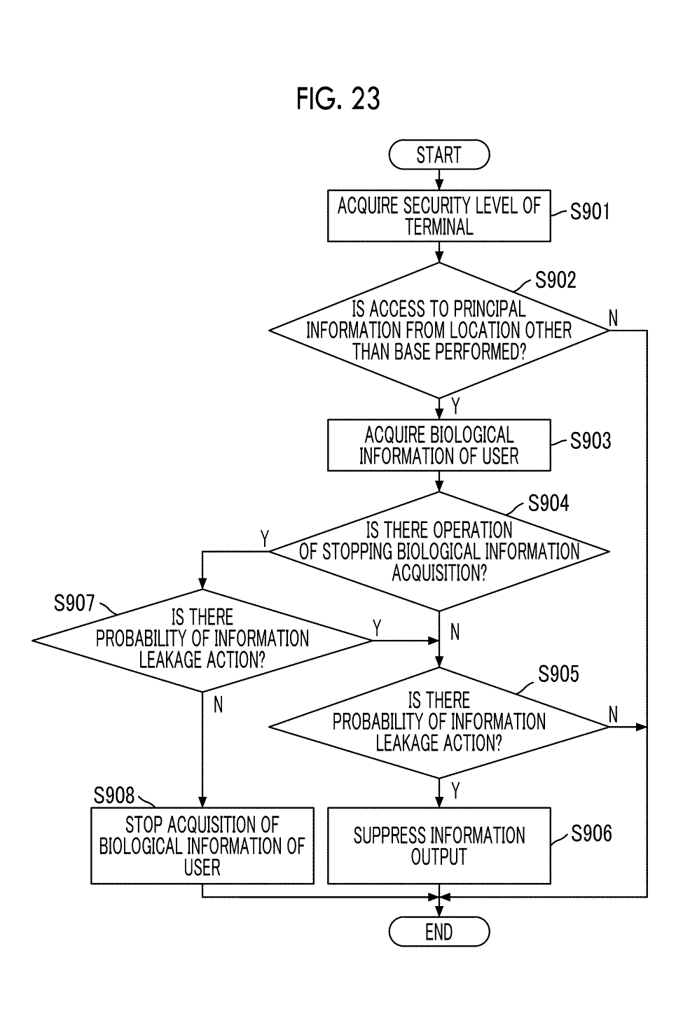

FIG. 23 is a flowchart illustrating the entire process in this case. This will be described by using the configuration of the modification example illustrated in FIGS. 21 and 22.

First, the user terminal 10 acquires a security level of the user terminal 10 (S901). Specifically, position data of the user terminal 10 which is being operated by the authorized user is acquired.

Next, the user terminal 10 determines whether or not the authorized user accesses principal information from a location other than the base by using the acquired position data (step S902). Whether or not the authorized user performs an operation is determined on the basis of the input user ID or password. Whether or not information is principal information is determined by collating information displayed on the user terminal 10 through an operation of the authorized user with principal information data stored in the memory 102. Whether or not access is performed from a location other than the base is determined by collating the acquired position data with position data of the base stored in the memory 102.

In a case where it is determined that the authorized user accesses the principal information from a location other than the base (YES in S902), the user terminal 10 determines that biological information of the authorized user is required to be acquired, and acquires the biological information of the authorized user (S903). The biological information is acquired, for example, by capturing a face image of the authorized user with a camera of the user terminal 10.

After the biological information is acquired, the user terminal 10 determines whether or not there is an operation of stopping acquisition of the biological information (S904). In a case where there is no stopping operation (No in S904), the user terminal 10 determines whether or not a mental state of the authorized user is within a normal range by collating the acquired biological information with the reference value data stored in the memory 102, and thus determines a probability of an information leakage action (S905). In a case where the acquired biological information is deviated from the reference value by a predetermined proportion or more, and thus is not within a normal range, it is determined that there is a probability of an information leakage action, and thus an information output suppression process is performed (S906). For example, lateral symmetry of the acquired face image is compared with the reference value, and, in a case where the symmetry is different from the reference value by a predetermined proportion or more, it is determined that the symmetry is not within a normal range, and the information output suppression process is performed.

On the other hand, in a case where there is the operation of stopping acquisition of the biological information (YES in S904), the user terminal 10 determines whether or not a mental state of the authorized user is within a normal range by collating the biological information acquired hitherto with the reference value data stored in the memory 102, and thus determines a probability of an information leakage action (S907). In a case where the acquired biological information is deviated from the reference value by a predetermined proportion or more, and thus is not within a normal range, it is determined that there is a probability of an information leakage action (YES in S907), and the stopping operation is disregarded, and the processes in S905 and S906 are continuously performed. In a case where the biological information is within the normal range (NO in S907), the biological information stops to be acquired in response to the stopping operation (S908).

In a case where an operation on the operation unit is received, it is determined that biological information acquired hitherto is within a normal range, and acquisition of the biological information is stopped, it may be assumed that a probability of an information leakage action cannot be determined, and thus information output may be uniformly suppressed.

### MODIFICATION EXAMPLE 8

In the exemplary embodiment, regarding an information output suppression process, a notification sent to the manager, masking of the screen, and replacement with another screen have been exemplified, but the screen may blink; a large volume may be output; an operation on the user terminal 10 may be locked; a face image of a third party not having authority may be captured and stored in the storage device 12f, and information indicating the fact may be displayed and also output in voices; and a room where the authorized user and a third party are present may be locked.

### MODIFICATION EXAMPLE 9

In the exemplary embodiment, as illustrated in FIG. 3, the control unit 202 of the information management server 12 realizes the biological information acquisition necessity determination unit, the information leakage action determination unit, and the information output suppression unit, but any one of the functional blocks may be realized by the control unit 104 of the user terminal 10. Specifically, the control unit 104 of the user terminal 10 may realize the biological information acquisition necessity determination unit and the information output suppression unit, and the information management server 12 may realize the information leakage action determination unit. In this case, there may be a configuration in which biological information is acquired in the user terminal 10 and is transmitted to the information management server 12, a probability of an information leakage action is determined in the information management server 12, a response about a result thereof is given to the user terminal 10, and information output is suppressed according to the determination result in the user terminal 10.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information management apparatus comprising:
an acquisition unit that acquires biological information for specifying a mental state during a specific operation of a user having authority over the specific operation for information; and
a control unit that performs control such that output of the information is suppressed in a case where the mental state specified by the acquired biological information is not within a preset normal range.

2. The information management apparatus according to claim 1,
wherein the acquisition unit acquires the biological information in a period from reception of an operation of displaying the information on a display until an operation of finishing the information display is received.

3. The information management apparatus according to claim 2,
wherein the acquisition unit acquires the biological information in a period in which information which is not allowed to be disclosed to a third party is displayed among pieces of the information.

4. The information management apparatus according to claim 1, further comprising:
an operation unit that gives an instruction for stopping acquisition of the biological information in the acquisition unit.

5. The information management apparatus according to claim 4,
wherein, in a case where the mental state specified by the biological information is within a preset normal range, the acquisition unit stops acquisition of the biological information in response to a stopping instruction from the operation unit.

6. The information management apparatus according to claim 4,
wherein, in a case where the acquisition unit stops acquisition of the biological information in response to a stopping instruction from the operation unit, the control unit suppresses output of the information.

7. The information management apparatus according to claim 1,
wherein the acquisition unit acquires the biological information in a case where a third party not having authority over the specific operation for the information is present near the user.

8. The information management apparatus according to claim 7,
wherein the acquisition unit acquires the biological information in a case where the third party visually recognizes a display on which the information is displayed.

9. The information management apparatus according to claim 1,
wherein the control unit suppresses output of the information by masking the information.

10. The information management apparatus according to claim 9,
wherein the control unit suppresses output of the information by masking the information in a case where a third party not having authority over the specific operation for the information is present near the user.

11. The information management apparatus according to claim 10,
wherein the control unit suppresses output of the information by masking the information in a case where the third party visually recognizes a display on which the information is displayed.

12. The information management apparatus according to claim 1,
wherein the control unit suppresses output of the information by outputting another piece of information instead of the information.

13. The information management apparatus according to claim 12,
wherein the control unit suppresses output of the information by outputting another piece of information instead of the information in a case where a third party not having authority over the specific operation for the information is present near the user.

14. The information management apparatus according to claim 1,
wherein the control unit cancels suppression of output of the information in a case where the mental state transitions from an outside of the normal range to an inside of the normal range.

15. The information management apparatus according to claim 10,
wherein the control unit cancels suppression of output of the information in a case where the third party is not present.

16. The information management apparatus according to claim 10,
wherein the control unit cancels suppression of output of the information in a case where the third party does not visually recognize a display on which the information is displayed.

17. The information management apparatus according to claim 1,
wherein the control unit suppresses output of the information in a case where a terminal outputting the information has moved.

18. The information management apparatus according to claim 1,
wherein the control unit suppresses output of the information by sending a notification to a manager.

19. The information management apparatus according to claim 1,
wherein the control unit notifies the user of acquisition of the biological information in response to the specific operation of the user.

20. The information management apparatus according to claim 19,
wherein the notification includes at least one of a risk due to leakage of the information or information regarding a person having a predetermined relationship with the user.
